(19) United States
(12) Patent Application Publication
(10) Pub. No.: US 2006/0089469 A1
(43) Pub. Date: Apr. 27, 2006

(54) Hydroxy diphosphines and their use in catalysis

(76) Inventors: Igor Komarov, Kiev (UA); Armin Boerner, Rostock (DE); Renat Kadyrov, Frankfurt (DE)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/514,241

(22) PCT Filed: May 20, 2003
(86) PCT No.: PCT/EP03/05286

§ 371 Date: Oct. 20, 2005

(30) Foreign Application Priority Data
May 27, 2002 (DE) 102-23-593.7

(51) Int. Cl. C08F 4/44; C07F 9/30; C07F 15/00

(52) U.S. Cl. 526/138; 556/20

(57) ABSTRACT

The invention relates to novel asymmetrical, chiral hydroxy diphosphines and to derivatives of general formula (I), in addition to their use as catalysts, in particular for enantioselective syntheses.

The present invention encompasses novel unsymmetrical chiral hydroxy-diphosphines and derivatives thereof, their synthesis and complexes of these compounds with transition metals and their use as catalysts for enantioselective transformations, in particular hydrogenations.

Bidentate organophosphorus compounds have attained great importance as ligands in homogeneous catalysis. Apart from the pure bidentate organophosphorus compounds, compounds having a further coordination position have proven to be interesting complexing ligands, in particular in the development of new catalysts, particularly in asymmetric syntheses (Börner, A.; Eur. J. Inorg. Chem. 2001, 327-337). An important aspect of the success of the diphosphine ligands is attributed to the creation of a particularly asymmetric environment around the metal center, although many of these ligands do not yet give satisfactory yields in catalytic reactions. A starting point for alleviating this problem is the use of modified diphosphine ligands.

There is therefore great interest in chiral organophosphorus ligands which contain a further coordination position and are additionally simple to prepare in a large number of structural variants which differ stereochemically and electronically in order to be able to find the optimum “tailored” ligand for a particular asymmetric catalysis.

It is an object of the present invention to provide novel, unsymmetrical, bidentate and chiral phosphorus ligand systems which have an additional coordination position for the substrate.

This object is achieved by a class of chiral, unsymmetrical bidentate organophosphorus compounds of the formula (I).

The present invention accordingly provides compounds of the general formula (I), 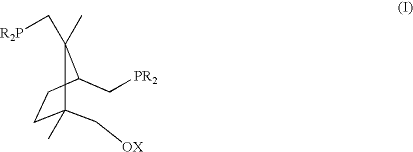
where the carbon skeleton of the compounds of the formula (I) can bear, in addition to the preferred hydrogen substituents, one or more linear, branched or cyclic (C₁-C₂₀)-alkyl substituents and the individual radicals
R are each, independently of one another, a radical selected from the group consisting of (C₁-C₂₄)-alkyl, (C₃-C₈)-cycloalkyl, (C₆-C₁₄)-aryl, phenyl, naphthyl, fluorenyl, (C₂-C₁₃)-heteroaryl, with the number of heteroatoms selected from the group consisting of N, O and S being able to be 1-2.

The abovementioned radicals themselves can each be mono-substituted or polysubstituted. These substituents can be, independently of one another, hydrogen, (C₁-C₂₀)-alkyl, (C₂-C₂₀)-alkenyl, (C₁-C₁₀)-haloalkyl, (C₃-C₈)-cycloalkyl, (C₂-C₉)-heteroalkyl, (C₆-C₁₀)-aryl, phenyl, naphthyl, fluorenyl, (C₂-C₆)-heteroaryl, with the number of heteroatoms, in particular from the group N, O and S, being able to be 1-4, (C₁-C₁₀)-alkoxy, preferably OMe, (C₁-C₉)-trihalomethyl-alkyl, preferably trifluoromethyl and trichloromethyl, halo, in particular fluoro and chloro, hydroxy, substituted amino of the formulae NH-alkyl-(C₁-C₈), NH-aryl-(C₅-C₆), N(alkyl-(C₁-C₈))₂, N(aryl-(C₅-C₆))₂, N-alkyl-(C₁-C₈)⁺₃, N-aryl-(C₅-C₆)⁺₃, NH—CO-alkyl-(C₁-C₈), NH—CO-aryl-(C₅-C₆), carboxylato of the formulae COOH and COOQ, where Q is either a monovalent cation or (C₁-C₈)-alkyl, (C₁-C₆)-acyloxy, sulfinato, sulfonato of the formulae SO₃H and SO₃Q, where Q is either a monovalent cation, (C₁-C₈)-alkyl or C₆-aryl, tri-(C₁-C₆)-alkylsilyl, in particular SiMe₃, and/or two radicals R are joined to one another, preferably forming a 4-8-membered ring which may be substituted by linear or branched radicals selected from the group consisting of (C₁-C₁₀)-alkyl, C₆-aryl, benzyl, (C₁-C₁₀)-alkoxy, hydroxy and benzyloxy.

X can be hydrogen, linear or branched (C₁-C₁₀)-alkyl, C₆-aryl, C(O)Y, where Y can be a linear or branched (C₁-C₁₀)-alkyl, C₆-aryl or benzyl radical.

P is a trivalent phosphorus.

The invention further provides complexes which contain a chiral bidentate organophosphorus ligand of the formula (I) and at least one metal. Such complexes are obtainable by simply combining the organophosphorus compounds of the invention with metal complex precursors in solution.

From the group of alkyl substituents, preference is given to methyl, ethyl, n-propyl, 1-methylethyl, n-butyl, 1-methylpropyl, 1,1-dimethylethyl, n-pentyl, 1-methylbutyl, 2-methylbutyl, 3-methylbutyl, 2,2-dimethylpropyl, 1-ethylpropyl, n-hexyl, 1,1-dimethylpropyl, 1,2-dimethylpropyl, 1-methylpentyl, 2-methylpentyl, 3-methylpentyl, 4-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl, 1-ethylbutyl, 2-ethylbutyl, 1,1,2-trimethylpropyl, 1,2,2-trimethylpropyl, 1-ethyl-1-methylpropyl, n-heptyl, n-octyl, n-nonyl, n-decyl.

Among the cyclic alkyl substituents, particular preference is given to substituted and unsubstituted cyclopentyl, cyclohexyl and cycloheptyl radicals.

Among the aryl substituents, particular preference is given to 2-alkylphenyl, 3-alkylphenyl, 4-alkylphenyl, 2,6-dialkylphenyl, 3,5-dialkylphenyl, 3,4,5-trialkylphenyl, 2-alkoxyphenyl, 3-alkoxyphenyl, 4-alkoxyphenyl, 3,5-dialkoxyphenyl, 3,5-dialkyl-4-alkoxyphenyl, 3,5-trifluoromethylphenyl, 4-trifluoromethylphenyl.

Finally, ligand systems of the formula (I) which are enriched in one enantiomer are preferred as optically active ligand systems. Particular preference is given to ligand systems in which the enantiomeric enrichment exceeds 90%, in particular 99%. In metal complexes, organophosphorus compounds of the formula (I) are able to create a highly asymmetric coordination sphere with organophosphorus donors which can be modified independently of one another around the metal center and thus make effective asymmetric induction possible. In addition, the simple manner in which different substituents can be introduced into the organophosphorus ligands enables the flexibility of the coordination sphere of the complex to be sterically controlled.

A broad spectrum of applications is thus available to compounds of the formula (I), since the bidentate phosphorus ligands can be optimized sterically and electronically by introduction of suitable substituents as a function of the catalytic synthesis.

The phosphorus compounds of the invention from the class of hydroxyphosphines can be prepared, for example, by the new process described below.

The synthesis utilizes “chiral pool” compounds such as (R)-camphor. A process described by Money (Nat. Prod. Rep. 1985, 2, 253) and by Lawrence (Ph. D. Thesis, UCLA, 1982) enables the 9-bromocamphor compounds to be prepared in a three-stage synthesis. The synthesis can likewise start out from commercially available 3-bromocamphor.

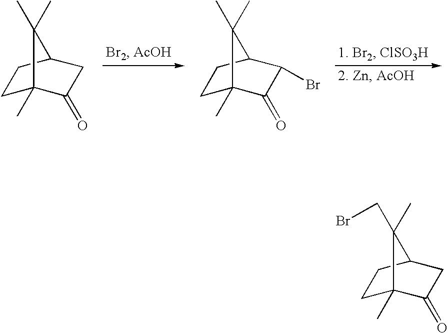

The (2-bromomethyl-3-hydroxymethyl-2,3-dimethylcyclopentyl)methanol is obtained by stepwise oxidation of 9-bromocamphor with selenium dioxide and hydrogen peroxide, followed by a reduction. A Bayer-Villinger reaction with a subsequent reduction has been found to be particularly advantageous. 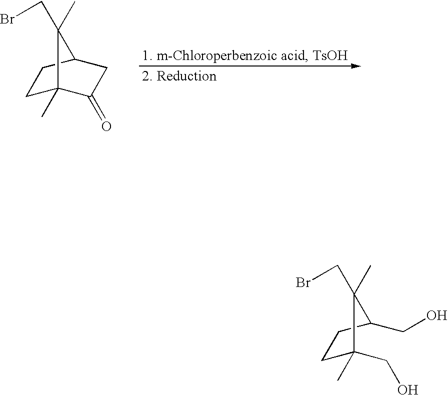
It has surprisingly been able to be shown that the diol obtained from (S)-camphor likewise has a very high optical purity (98% ee) although the starting material has an optical purity of only 79-93% ee.

The diol is converted selectively on the sterically less hindered position into the monotosylate. In a further reaction step, the free hydroxy group is blocked by means of a suitable protective group. Instead of the tosyl group, another functional group which aids nucleophilic substitution in the further course of the reaction can also be present in this position. 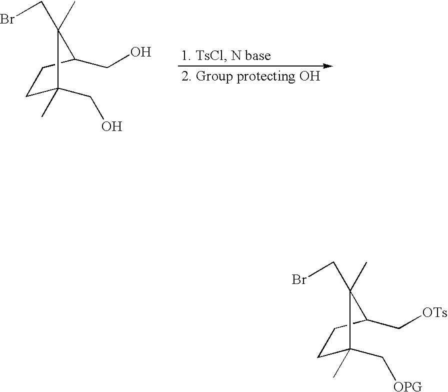
Nucleophilic substitution by means of a phosphorus-containing reagent which is commercially available or can be prepared by a person skilled in the art using reagents known for this purpose (cf., for example, A Guide To Organophophorus Chemistry, Louis D. Quin, John Wiley & Sons 2000) forms the diphosphine. Subsequent elimination of the protective group gives the ligand of the invention which has C1 symmetry and an additional free coordination position. 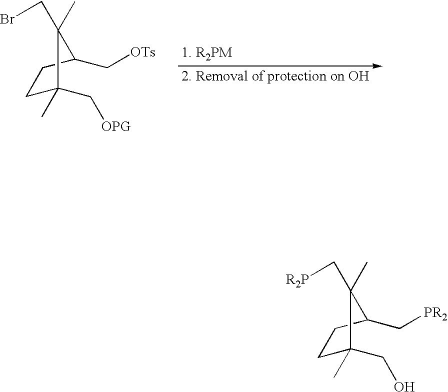
The ligand system can be modified in any desired way within the scope of the claims using methods with which those skilled in the art are familiar, in particular by further variations on the free hydroxy group, e.g. by esterifying or etherifying it.

The compounds of the invention can be obtained particularly simply in a wide range of variations starting from simple starting materials by means of the preparative process described, in contrast to many established ligand systems. Thus, variation of the substituents on the phosphorus and oxygen enable the electronic and steric properties of the ligand according to the invention to be influenced in a targeted way, so that yield, selectivity and activity in homogeneously catalyzed processes can be controlled.

Due to the ease with which they can be obtained, the ligands can be made available for industrial production.

The compounds of the general formula (I) can be used as ligands on transition metals in asymmetric, metal-catalyzed reactions such as hydrogenation, hydroformylation, rearrangement, allylic alkylation, cyclopropanation, hydrosilylation, hydride transfers, hydroborations, hydrocyanations, hydrocarboxylations, aldol reactions or the Heck reaction, and also in polymerizations. They are particularly suitable for asymmetric reactions.

The ligands of the invention are particularly useful in the asymmetric hydrogenation of C═C, C═O or C═N bonds, in which they display high activities, yields, sometimes up to 100%, and selectivities, and in asymmetric hydroformylation.

Particularly useful catalysts for hydrogenations have been found to be, for example, Ru and Rh complexes containing a ligand of the formula (I) according to the invention.

The catalytic complexes can be formed either directly in a one-pot reaction by simply combining ligand and metal, metal salt or metal precomplex or can be prepared beforehand and isolated and added to the reaction mixture as finished complex.

Suitable catalysts are, for example, complexes of the general formula (II) containing novel compounds of the formula (I) as ligands,
[MₓP_{y}L_{z}S_{q}]Aᵣ (II)
where, in the general formula (II), M is a transition metal center, preferably of groups VIIb, VIIIb and Ib of the Periodic Table, L represents identical or different coordinating organic or inorganic ligands and P represents bidentate organophosphorus ligands of the formula (I) according to the invention, S represents coordinating solvent molecules and A represents equivalents of noncoordinating anions, where x is 1 or 2, y is an integer greater than or equal to 1 and z, q and r are each, independently of one another, an integer greater than or equal to 0. An upper limit is imposed on the sum y+z+q by the coordination sites available on the metal centers, with not all coordination sites having to be occupied.

The complexes of the invention contain at least one transition metal atom or ion, in particular from the group consisting of palladium, platinum, rhodium, ruthenium, osmium, iridium, cobalt, nickel, and copper.

Preferred ligands L in such complexes are halide, in particular Cl, Br and I, diene, in particular cyclooctadiene, norbornadiene, olefin, in particular ethylene and cyclooctene, acetato, trifluoracetato, acetylacetonato, allyl, methallyl, alkyl, in particular methyl and ethyl, nitrile, in particular acetonitrile and benzonitrile, and also carbonyl and hydrido ligands.

Preferred coordinating solvents S are amines, in particular triethylamine, alcohols, in particular methanol and aromatics, in particular benzene and cumene.

Preferred noncoordinating anions A are trifluoroacetate, trifluoromethanesulfonate, BF₄, ClO₄, PF₆, SbF₆ and BAr₄.

In the individual complexes, different molecules, atoms or ions of the individual constituents M, P, L, S and A can be present.

These metal-ligand complexes can be prepared in situ by reaction of a metal salt or an appropriate precomplex with the ligands of the general formula (I). A metal-ligand complex can also be obtained by reaction of a metal salt or an appropriate precomplex with the ligands of the general formula (I) and subsequent isolation. Such complexes are preferably produced in a one-pot reaction with stirring at elevated temperature. Catalytically active complexes can also be produced directly in the reaction mixture of the planned catalytic reaction.

Examples of metal salts are metal chlorides, bromides, iodides, cyanides, nitrates, acetates, acetylacetonates, hexafluoroacetylacetonates, tetrafluoroborates, perfluoroacetates or triflates, in particular of palladium, platinum, rhodium, ruthenium, osmium, iridium, cobalt, nickel and/or copper.

Examples of precomplexes are:
cyclooctadienepalladium chloride, cyclooctadienepalladium iodide, 1,5-hexadienepalladium chloride, 1,5-hexadienepalladium iodide, bis(dibenzylideneacetone)-palladium, bis(acetonitrile)palladium(II) chloride, bis(acetonitrile)palladium(II) bromide, bis(benzonitrile)palladium(II) chloride, bis(benzonitrile)palladium(II) bromide, bis(benzonitrile)palladium(II) iodide, bis(allyl)palladium, bis(methallyl)palladium, allylpalladium chloride dimer, methallylpalladium chloride dimer, tetramethylethylenediaminepalladium dichloride, tetramethylethylenediamine-palladium dibromide, tetramethylethylenediaminepalladium diiodide, tetramethylethylenediaminepalladium dimethyl, cyclooctadieneplatinum chloride, cyclooctadieneplatinum iodide, 1,5-hexadieneplatinum chloride, 1,5-hexadieneplatinum iodide, bis(cyclooctadiene)platinum, potassium ethylenetrichloroplatinate, cyclooctadienerhodium(I) chloride dimer, norbornadienerhodium(I) chloride dimer, 1,5-hexadienerhodium(I) chloride dimer, tris(triphenylphosphine)rhodium(I) chloride, hydridocarbonyltris(triphenylphosphine)rhodium(I) chloride, bis(cyclooctadiene)-rhodium(I) perchlorate, bis(cyclooctadiene)rhodium(I) tetrafluoroborate, bis(cyclooctadiene)rhodium(I) triflate, bis(acetonitrile)(cyclooctadiene)rhodium(I) perchlorate, bis(acetonitrile)(cyclooctadiene)rhodium(I) tetrafluoroborate, bis(acetonitrile)(cyclooctadiene)rhodium(I) triflate, cyclopentadienerhodium(III) chloride dimer, pentamethylcyclopentadienerhodium(II) chloride dimer, (cyclooctadiene)Ru(η³-allyl)₂, ((cyclooctadiene)Ru)₂(acetate)₄, ((cyclooctadiene)Ru)₂(trifluoroacetate)₄, RuCl₂(arene) dimer, tris(triphenylphosphine)-ruthenium(II) chloride, cyclooctadieneruthenium(II) chloride, OsCl₂(arene) dimer, cyclooctadieneiridium(I) chloride dimer, bis(cyclooctene)iridium(I) chloride dimer, bis(cyclooctadiene)nickel, (cyclododecatriene)nickel, tris(norbornene)nickel, nickeltetracarbonyl, nickel(II) acetylacetonate, (arene)copper triflate, (arene)copper perchlorate, (arene)copper trifluoroacetate, cobalt carbonyl.

### EXAMPLES

### Example 1

### (1R,5R,8R)-8-(Bromomethyl)-1,8-dimethyl-3-oxabicyclo[3.2.1]octan-2-one

A solution of 4.3 mmol (1.0 g) of (+)-9-bromocamphor, 6.5 mmol (1.12 g) of m-chloroperbenzoic acid and 100 mg of p-toluenesulfonic acid in 40 ml of dichloromethane is refluxed for 4 days. Every day, a further 40 mg of m-chloro-perbenzoic acid are added to the reaction solution. After four days, the solution is diluted with 100 ml of ether and washed with saturated sodium hydrogencarbonate solution, with sodium sulfite solution, again with saturated sodium hydrogen-carbonate solution and with water. The organic phase is dried and the solvent is removed under reduced pressure. The crude product is purified by means of chromatography and the product is obtained in a yield of 33%.

¹H-NMR (CDCl₃):

δ=4.41 (ddd, 1H), 4.15 (d, 1H), 3.39 (dq, 1H), 3.25 (d, 1H), 2.46 (dd, 1H), 2.08 (m, 2H), 1.95 (m, 2H), 1.18 (d, 3H), 1.16 (s, 3H) ppm.

### Example 2

### (1R,2R,3S)-(2-Bromomethyl-3-hydroxymethyl-2,3-dimethylcyclopentyl)-methanol

0.61 mmol (150 mg) of (1R,5R,8R)-8-(bromomethyl)-1,8-dimethyl-3-oxa-bicyclo[3.2.1]octan-2-one is dissolved in 10 ml of ether. 1.22 mmol (46.1 mg) of lithium aluminum hydride is added in small portions to this solution and the reaction solution is stirred for a further 15 minutes. The reaction solution is hydrolyzed with water, the residue is filtered off and washed a number of times with ether. The filtrate is dried and the solvent is removed. The crude product is obtained in quantitative yield and is used without further purification.

¹H-NMR (CD₃OD):

δ=3.48-3.65 (m, 4H), 3.22-3.33 (m, 4H), 2.08 (m, 1H), 1.75-1.86 (m, 1H), 1.60-1.70 (m, 1H), 1.26-1.38 (m, 2H), 0.97 (s, 3H), 0.88 (s, 3H) ppm.

### Example 3

### [(1R,2R,3S)-(2-Bromomethyl)-3-hydroxymethyl)-2,3-dimethylcyclopentyl]methyl 4-tosylate

10.7 mmol (2.05 g) of p-toluenesulfonyl chloride are added at −10° C. to a solution of 10.7 mmol (2.7 g) of (1R,2R,3S)-(2-bromomethyl-3-hydroxymethyl-2,3-dimethyl-cyclopentyl)methanol in 10 ml of pyridine over a period of 15 minutes. The solution is stirred at this temperature for 45 minutes and subsequently hydrolyzed with 75 ml of water. The aqueous phase is extracted with 150 ml of ether. The organic phase is subsequently washed with 50 ml of water, 5% strength hydrochloric acid and water. After the organic phase has been dried, the solvent is removed under reduced pressure and the crude product is purified by means of chromatography. The product is used immediately in the next reaction step.

¹H-NMR (CDCl₃):

δ=7.77 (d, 2H), 7.34 (d, 2H), 4.30 (d, 1H), 4.01 (d, 1H), 3.75 (dd, 1H), 3.67 (d, 1H), 3.58 (dd, 1H), 3.54 (d, 1H), 2.44 (s, 3H), 2.15 (m, 1H), 1.85 (m, 2H), 1.62 (m, 1H), 1.48 (m,1H), 1.29 (m,1H), 1.00 (s, 3H), 0.93 (s, 3H) ppm.

### Example 4

### [(1R,2R,3S)-(2-Bromomethyl)-2,3-dimethyl-3-[(tetrahydro-2H-pyran-2-yloxy)methyl]cyclopentyl]methyl 4-methylbenzenesulfonate

7.3 mmol (2.96 g) of [(1R,2R,3S)-(2-bromomethyl)-3-hydroxymethyl)-2,3-dimethylcyclopentyl]methyl 4-tosylate are dissolved in 20 ml of dichloromethane. 10.95 mmol (1 ml) of 3,4-dihydro-2H-pyrane and pyridinium p-toluenesulfonate are added to this solution and the mixture is stirred overnight. The reaction solution is subsequently diluted with 100 ml of ether and washed with sodium chloride solution and water. The organic phase is dried and the solvent is removed under reduced pressure. The crude product is obtained in quantitative yield and is used without further purification.

¹H-NMR (CDCl₃):

δ=7.76 (d, 2H), 7.33 (d, 2H), 4.50 (m, 2H), 4.28 (dd, 1H), 3.00-4.00 (m, 6H), 2.44 (s, 3H), 1.10-2.40 (m, 11H), 0.85-1.05 (m, 6H) ppm.

### Example 5

### [(1R,2R,3S)-1,2-Dimethyl-2,3-bis(diphenylphosphinomethyl)cyclopentyl]methanol

A solution of 0.94 mmol (0.46 g) of [(1R,2R,3S)-(2-bromomethyl)-2,3-dimethyl-3-[(tetrahydro-2H-pyran-2-yloxy)methyl]cyclopentyl]methyl 4-methylbenzene-sulfonate dissolved in 5 ml of THF is added to a solution of 2.3 mmol of lithium diphenylphosphide in 10 ml of THF while cooling in ice. The solution is stirred at room temperature for 2 hours and subsequently refluxed for 90 minutes. The reaction solution is hydrolyzed with 20 ml of water and the aqueous phase is extracted with 70 ml of ether. The organic phase is subsequently washed twice with water and dried at 50° C. under reduced pressure for 4 hours. The residue is taken up in 8 ml of ethanol and 25 mg of pyridinium p-toluenesulfonate are added. The solution is stirred at 55° C. for 2 days. The solvent is removed under reduced pressure and the crude product is purified by means of chromatography. The compound is obtained as an oil in a yield of 43%.

¹H-NMR (C₆D₆):

δ=7.75 (t, 2H), 7.58-7.62 (m, 4H), 7.57 (t, 2H), 6.95-7.10 (m, 12H), 3.75 (d, 1H), 3.30 (d, 1H), 3.48 (br, s, 1H), 3.12 (dq, 1H), 1.90-2.00 (m, 1H), 2.63 (dd, 1H), 2.32 (dd, 1H), 2.19-2.30 (dd, 1H), 2.19-2.30 (m, 2H), 1.15-1.50 (m, 3H), 1.02 (s, 3H), 0.92 (s, 3H) ppm.

³¹P-NMR (C₆D₆):

δ=−15.7, −22.7 ppm.

### Example 6

### Preparation of the Rh Complex

1 mmol of [Rh(COD)acac] is added to a solution of 1 mmol of the diphosphine (example 5) in 2 ml of THF. An equimolar amount of 40% strength tetrafluoroboronic acid is subsequently added and the mixture is stirred for a further 15 minutes. The metal complex is precipitated by addition of 20 ml of ether, redissolved by addition of 0.5 ml of dichloromethane and precipitated again by addition of ether. The metal complex is filtered off and dried under reduced pressure.

³¹P-NMR (CDCl₃):

δ=22.3 (dd), 16.7 (dd) ppm.

### Example 7

### Hydrogenation

All hydrogenations were carried out at 25° C. in 15 ml of solvent under a hydrogen pressure of 1 bar. Substrate and catalyst (example 6) were used in a ratio of 100:1.

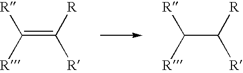

| | | | | | | | Conversion | |
|---|---|---|---|---|---|---|---|---|
| R | R′ | R″ | R′′′ | Solvent | Time | | % | ee % |
| COOMe | NHAc | H | Ph | MeOH | 1.5 | min | 100 | 11 (S) |
| COOMe | NHAc | H | Ph | CH₂Cl₂ | 5 | min | 100 | 24 (S) |
| COOH | NHAc | H | H | MeOH | 1.5 | min | 100 | 57 (S) |
| COOH | NHAc | H | H | CH₂Cl₂ | 8 | min | 100 | 49 (S) |
| CH₂COOMe | COOMe | H | H | MeOH | 6 | min | 100 | 70 (S) |
| CH₂COOMe | COOMe | H | H | CH₂Cl₂ | 3.5 | min | 100 | 75 (S) |
| CH₂COOH | COOH | H | H | MeOH | 1.5 | min | 100 | 9 (S) |
| CH₂COOH | COOH | H | H | CH₂Cl₂ | 300 | min | 62 | 10 (S) |
| COOMe | H | Me | NHAc | MeOH | 40 | min | 100 | 93(R) |
| COOMe | H | Me | NHAc | CH₂Cl₂ | 12 | min | 100 | 95 (R) |
| COOMe | H | Me | NHAc | toluene | 300 | min | 98 | 97 (R) |
| COOMe | H | NHAc | Me | MeOH | 20 | min | 100 | 46 (R) |
| COOMe | H | NHAc | Me | CH₂Cl₂ | 45 | min | 72 | 58 (R) |
| COOMe | H | NHAc | Me | toluene | 700 | min | 7 | 50 (R) |
| COOH | H | Me | NHAc | MeOH | 120 | min | 82 | 81 (R) |
| COOH | H | Me | NHAc | CH₂Cl₂ | 24 | h | 54 | 82 (R) |
| COOH | H | NHAc | Me | MeOH | 13 | h | 53 | 54 (R) |
| COOH | H | NHAc | Me | CH₂Cl₂ | 24 | h | 8 | 12 (R) |
| CONHCH₂ | H | Me | NHAc | CH₂Cl₂ | 13 | h | 50 | 80 |
| COOMe | | | | | | | | |
| CONH(CH₂)₂ | H | Me | NHAc | CH₂Cl₂ | 13 | h | 90 | 33 |
| COOMe | | | | | | | | |

1. A compound of the formula (I), 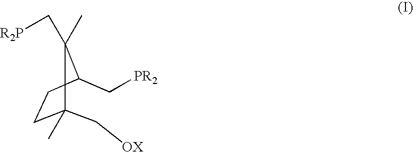
wherein the carbon skeleton of said compound of the formula (I) can bear one or more linear, branched or cyclic (C₁-C₂₀)-alkyl substituents and the individual radicals R are each, independently of one another, a radical selected from the group consisting of (C₁-C₂₄)-alkyl, (C₃-C₈)-cycloalkyl, (C₆-C₁₄)-aryl, phenyl, naphthyl, fluorenyl, and (C₂-C₁₃)-heteroaryl, with the number of heteroatoms selected from the group consisting of N, O and S being able to be 1-2, and said radicals R can each be, independently of one another, monosubstituted or polysubstituted and the substituents are selected from the group consisting of hydrogen, (C₁-C₂₀)-alkyl, (C₂-C₂₀)-alkenyl, (C₁-C₁₀)-haloalkyl, (C₃-C₈)-cycloalkyl, (C₂-C₉)-heteroalkyl, (C₆-C₁₀)-aryl, phenyl, naphthyl, fluorenyl, (C₂-C₆)-heteroaryl, with the number of heteroatoms selected from the group consisting of N, O and S being able to be 1-4, (C₁-C₁₀)-alkoxy, (C₁-C₉)-trihalomethylalkyl, halo, hydroxy, substituted amino of the formulae NH-alkyl-(C₁-C₈), NH-aryl-(C₅-C₆), N(alkyl-(C₁-C₈))₂, N(aryl-(C₅-C₆))₂, N-alkyl-(C₁-C₈)⁺₃, N-aryl-(C₅-C₆)⁺₃, NH—CO-alkyl-(C₁-C₈), and NH—CO-aryl-(C₅-C₆), carboxylato of the formulae COOH and COOQ, where Q is either a monovalent cation or (C₁-C₈)-alkyl, (C₁-C₆)-acyloxy, sulfinato, sulfonato of the formulae SO₃H and SO₃Q, where Q is either a monovalent cation, (C₁-C₈)-alkyl or C₆-aryl, tri-(C₁-C₆)-alkylsilyl, with two radicals R also being able to be joined to one another to form a ring which may be substituted by linear or branched radicals selected from the group consisting of (C₁-C₁₀)-alkyl, C₆-aryl, benzyl, (C₁-C₁₀)-alkoxy, hydroxy and benzyloxy,
X is hydrogen, linear or branched (C₁-C₁₀)-alkyl, C₆-aryl or a C(O)Y radical, where Y can be a linear or branched (C₁-C₁₀)-alkyl, C₆-aryl or benzyl radical, and
P is a trivalent phosphorus.

2. The compound as claimed in claim 1, wherein said radicals R are independent of each other 1-methylethyl, tert-butyl, methyl, ethyl, cyclohexyl, cyclopentyl, phenyl, 2-methylphenyl, 3,5-dimethylphenyl, 4-methylphenyl, 4-methoxyphenyl, 3,5-bis(trifluoromethyl)phenyl, 4-trifluoromethylphenyl, 3,5-dimethyl-4-methoxyphenyl, 4-phenoxyl, 4-dialkyamino, 2-alkylphenyl, 3-alkylphenyl, 4-alkylphenyl, 2,6-dialkylphenyl, 3,5-dialkylphenyl, 3,4,5-trialkylphenyl, 2-alkoxyphenyl, 3-alkoxyphenyl, 4-alkoxyphenyl, 2,6-dialkoxylphenyl, 3,5-dialkoxyphenyl, 3,4,5-trialkoxyphenyl, 3,5-dialkyl-4-alkoxyphenyl, 3,5-dialkyl-4-dialkylaminophenyl, 4-dialkylamino, 3,5-trifluoromethyl, or 4-trifluoromethyl.

3. The compound as claimed in claim 1, wherein said radicals R are independent of each other phenyl, 2-methylphenyl, 3,5-dimethylphenyl, 4-methylphenyl, 4-methoxyphenyl, 3,5-bis(trifluoromethyl)phenyl, 4-trifluoromethylphenyl, 3,5-dimethyl-4-methoxyphenyl, or cyclohexyl, and
X is hydrogen, methyl, methoxymethyl, ethyl or acetyl.

4. The compound as claimed in claim 1, wherein said compound is enantiomerically enriched.

5. The compound as claimed in claim 4, wherein the enantiomeric enrichment exceeds 90%.

6. A complex obtained by combining at least one transition metal salt or a transition metal precomplex with said compound as claimed in claim 1.

7. A complex of the general formula (II)
[MₓP_{y}L_{z}S_{q}]Aᵣ (II)
wherein
M represents a transition metal center,
L represents identical or different coordinating organic or inorganic ligands,
S represents coordinating solvent molecules and
A represents equivalents of noncoordinating anions,
where x is 1 or 2, y is an integer greater than or equal to 1, z, q and r are integers greater than or equal to 0, with the upper limit to the sum y+z+q being imposed by the coordination sites available on the metal centers but not all coordination sites having to be occupied, and
P is said compound as claimed in claim 1.

8. The complex as claimed in claim 6, wherein said complex comprises at least one metal selected from the group consisting of Ru, Co, Rh, Ir, Ni, Pd, Pt, Cu, and mixtures thereof.

9-11. (canceled)

12. A method of carrying out asymmetric reaction or polymerization, said method comprising:
incorporating a catalyst which comprises said complex as claimed in claim 6 in said asymmetric reaction or polymerization.

13. A method of carrying out asymmetric hydrogenation, hydroformylation, rearrangement, allylic alkylation, cyclopropanation, hydrosilylation, hydride transfer reaction, hydroboration, hydrocyanation, hydrocarboxylation, aldol reaction or Heck reaction, said method comprising:
incorporating a catalyst which comprises said complex as claimed in claim 6 in said asymmetric hydrogenation, hydroformylation, rearrangement, allylic alkylation, cyclopropanation, hydrosilylation, hydride transfer reaction, hydroboration, hydrocyanation, hydrocarboxylation, aldol reaction or Heck reaction.

14. A method of carrying out asymmetric hydrogenation and/or hydroformylation, said method comprising:
incorporating a catalyst which comprises said complex as claimed in claim 6 in said asymmetric hydrogenation and/or hydroformylation.
